(19) United States
(12) Patent Application Publication
(10) Pub. No.: US 2026/0322297 A1
(43) Pub. Date: Oct. 15, 2026

(54) OFFSET CORRECTION DEVICE AND METHOD OF MOTOR POSITION SENSOR, AND VEHICLE CONTROL SYSTEM INCLUDING THE SAME

(71) Applicant: HL MANDO CORPORATION, Pyeongtaek-si (KR)

(72) Inventor: Yunjai OH, Pyeongtaek-si (KR)

(73) Assignee: HL MANDO CORPORATION, Pyeongtaek-si (KR)

(21) Appl. No.: 19/441,081

(22) Filed: Jan. 6, 2026

(30) Foreign Application Priority Data
Mar. 25, 2025 (KR) 10-2025-0038258
Aug. 4, 2025 (KR) 10-2025-0106568

(51) Int. Cl. H02P 21/09; B60L 15/20; B62D 5/04; G01D 5/14; H02P 21/18

(52) U.S. Cl. CPC H02P 21/09; G01D 5/14; H02P 21/18; B60L 15/20; B62D 5/046

(57) ABSTRACT

The present embodiments relate to an offset correction device and method of a motor position sensor. The offset correction device of a motor position sensor according to present embodiments may include a memory storing at least one instruction, and at least one processor executing the at least one instruction, wherein the least one processor is configured to, by executing the at least one instruction, acquire motor response information corresponding to a motor, determine an offset error based on the motor response information, correct position information of the MPS based on the offset error and generate a control signal for the motor based on the corrected position information to control an operation of the motor.

### CROSS REFERENCE TO RELATED APPLICATION

This application claims priority from Korean Patent Application No. 10-2025-0038258, filed on Mar. 25, 2025 and Korean Patent Application No. 10-2025-0106568, filed on Aug. 4, 2025, which are hereby incorporated by reference for all purposes as if fully set forth herein.

### TECHNICAL FIELD

Embodiments of the present disclosure relate to an offset correction device and method of a motor position sensor, and a vehicle control system including the same.

### BACKGROUND

In general, a motor position sensor (MPS) may detect a rotational position of a motor and provides information thereon to a control unit. It is important to accurately recognize the position during initial motor operation, and requires an offset compensation to ensure a sensor accurately identifies a current position as a reference position (e.g., 0 degrees). If offset compensation is not performed, the control unit may control current based on incorrect angle information, preventing the motor from accurately outputting the intended torque.

In a system such as a steering assistance system, there may occur an offset error which may cause assist torque to be applied in the opposite direction or cause differences in steering feeling when steering left and right, and which may potentially compromise steering stability. Furthermore, in a braking system, large offset errors may lead to differences in a clamping force between wheels, which may cause a yaw moment and potentially degrade driving stability.

The motor offset compensation can be typically performed electronically or through software, and may be implemented by forced alignment or high-precision encoder-based identification techniques. However, these methods are primarily effective in the case that a motor is used alone or the mechanical structure is not assembled.

A motor may be mostly used with mechanical structures, such as gears, assembled together. In these situations, potential for identification errors may increase due to mechanical clearance and friction if electronic or software-based offset compensation is applied. That is, offset identification accuracy may deteriorate in a state in which the mechanical structure is assembled.

Therefore, it is required a high-precision compensation technique capable of reliably identifying and compensating an offset of the motor position sensor even when the mechanical structure is assembled.

### SUMMARY

Embodiments of the present disclosure are to provide an offset correction device and method of a motor position sensor capable of identifying and correcting the offset of a motor position sensor.

In accordance with an aspect of the present disclosure, there may be provided an offset correction device of a motor position sensor (MPS), including a memory storing at least one instruction, and at least one processor executing the at least one instruction, wherein the least one processor is configured to, by executing the at least one instruction, acquire motor response information corresponding to a motor, determine an offset error based on the motor response information, correct position information of the MPS based on the offset error and generate a control signal for the motor based on the corrected position information to control an operation of the motor.

In accordance with another aspect of the present disclosure, there may be provided an offset correction method of a motor position sensor, including a step of acquiring motor response information corresponding to a motor, determining an offset error based on the motor response information, correcting position information of the MPS based on the offset error and generating a control signal for the motor based on the corrected position information to control an operation of the motor.

In accordance with another aspect of the present disclosure, there may be provided vehicle control system including a vehicle control device for controlling a driving of a vehicle, a motor for driving the vehicle, a motor position sensor for detecting a rotational position of the motor, and an offset correction device configured to generate motor response information based on a stator voltage of the motor, determine an offset error based on the motor response information, and correct position information of the MPS based on the offset error, wherein the vehicle control device is configured to generate a control signal for the motor based on the corrected position information to control an operation of the motor.

According to the present embodiments, it is possible to provide an offset correction device and method of a motor position sensor capable of identifying and correcting the offset of a motor position sensor.

### BRIEF DESCRIPTION OF THE DRAWINGS

FIG. 1 is a block diagram of an exemplary computing system that can be used in the present disclosure.

FIG. 2 is an exemplary flowchart illustrating an offset correction process of a motor position sensor according to an embodiment of the present disclosure.

FIG. 3 is an exemplary flowchart illustrating a process for obtaining motor response information according to an embodiment of the present disclosure.

FIG. 4 is a block diagram schematically illustrating a motor position sensor offset correction flow according to an embodiment of the present disclosure.

FIG. 5 illustrates experimental results demonstrating that stable offset correction is performed regardless of the initial offset value when applying the motor position sensor offset correction method according to the present disclosure.

FIG. 6A illustrates that, when applying the motor position sensor offset correction method according to the present disclosure, the final offset identification value (θr,Offset,final) gradually increases over time and reaches a stable steady-state value after a specific time point.

FIG. 6B illustrates a change state along the time axis of the offset identification value (θr,Offset,cal) calculated through an inverse tangent operation according to the present disclosure.

FIG. 6C illustrates a graph showing the temporal change of an offset error (θr,Offset,error) according to the present disclosure.

FIG. 7A illustrates offset identification response characteristics when a motor position sensor offset correction method according to the present disclosure is applied.

FIG. 7B illustrates experimental results evaluating the offset identification response characteristics and a steady-state angular error when a motor position sensor offset correction method according to the present disclosure is applied.

FIG. 8A illustrates a graph illustrating identification accuracy (e.g., angular error) according to an initial MPS offset value.

FIG. 8B illustrates the results of evaluating response characteristics according to an initial MPS offset value.

FIG. 8C illustrates the results of evaluating steady-state pulsation (e.g., angular pulsation range) according to an initial MPS offset value.

FIG. 9 is an exemplary flowchart illustrating a motor position sensor offset correction method according to an embodiment of the present disclosure.

FIG. 10 is a block diagram illustrating the configuration of a vehicle control system according to another embodiment of the present disclosure.

### DETAILED DESCRIPTION

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

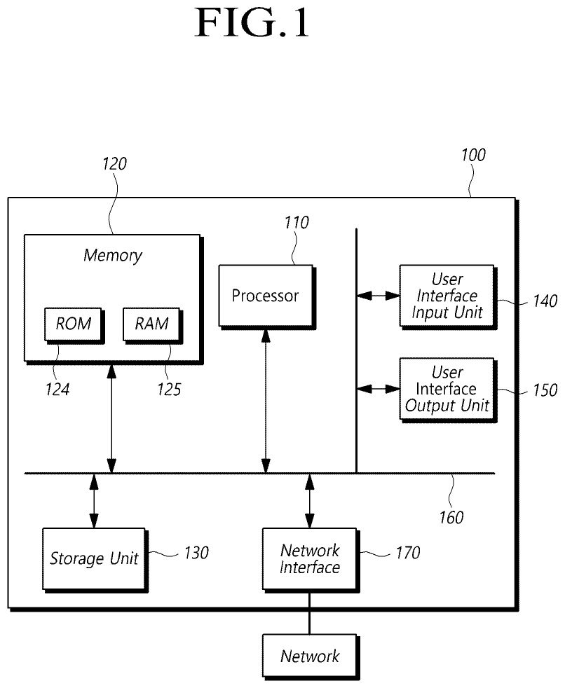

FIG. 1 is a block diagram of an exemplary computing system that can be used in the present disclosure.

Referring to FIG. 1, a computer system 100 may be configured to include one or more processors 110, memory 120, storage 130, user interface input 140, user interface output 150, bus 160, and network interface 170, reflecting the hardware configuration of a motor position sensor offset correction device.

The processor 110 is a central processing unit (CPU) or other semiconductor device that performs computational functions, and may execute instructions stored in the memory 120 and/or storage 130 to identify an offset of the motor position sensor, calculate an offset correction value, correct final position information, and perform a state filter-based correction operation.

The memory 120 may include volatile memory and non-volatile memory, and may include, for example, a read-only memory (ROM) 124 and a random access memory (RAM) 125. ROM 124 may store device initialization settings, default values of offset correction algorithms, etc., and RAM 125 may be used to store temporary data such as position information received from a motor position sensor, offset identification calculation intermediate values, and filter calculation values.

The storage 130 may include various non-volatile storage media such as a hard disk drive (HDD), a solid state drive (SSD), and an embedded multi-media card (eMMC), and may be used to store, for example, correction history data, offset correction result records, sensor parameters, and diagnostic logs.

The user interface input 140 is a component for system settings, diagnosis, and receiving user commands, and may include a touch screen, button switches, and external input terminals. The user interface output 150 is a component for displaying correction status, correction results, and sensor status, may be implemented with a display, LED, or warning sound module for outputting such information.

The bus 160 may serve as an internal data path for data transmission and reception between the components, enabling each component to be organically interconnected.

Furthermore, the computer system 100 may include a network interface 170 for connection with an in-vehicle CAN communication network or other vehicle networks, and may perform communication functions for data exchange with an external electronic control unit (ECU), remote diagnosis, or receiving correction commands.

According to an embodiment of the present disclosure, a motor position sensor offset correction device may be mounted on an electronic control unit (ECU) of a vehicle or a corresponding control board, and may precisely identify and correct the offset of a motor position sensor, thereby providing stable position information even under various driving conditions.

Typically, an offset correction of a motor position sensor may be performed on a motor (or electric motor) alone, i.e., in a state in which the related mechanical structure is not assembled. For example, when the related mechanical structure is not assembled, a method of compensating the motor position offset using forced alignment or a high-precision encoder may be commonly used. However, if the mechanical structures such as gears and reducers are assembled to a motor, offset identification accuracy may deteriorate due to clearance or friction in the mechanical components even if electronic or software methods are applied. That is, if the mechanical structures are assembled, it may be difficult to secure sufficient identification accuracy using the offset correction methods utilizing forced alignment or high-precision encoders.

A motor position sensor offset correction device according to an embodiment of the present disclosure may determine motor response information based on a stator voltage of the motor and then identify an offset error based on the motor response information. For example, the motor position sensor offset correction device according to the present disclosure may identify an offset error based on motor response information under a specific motor driving situation, without directly receiving offset information from the motor position sensor. The identified offset error may be converted into a stably compensated correction value through a state filter and then applied to the position information of the motor position sensor to generate final position information.

The motor position sensor offset correction device according to the present disclosure can precisely identify and compensate for offsets without a separate mechanism disassembly process even when the mechanism structure is assembled, and can stably secure high-precision position control performance even under various operating conditions.

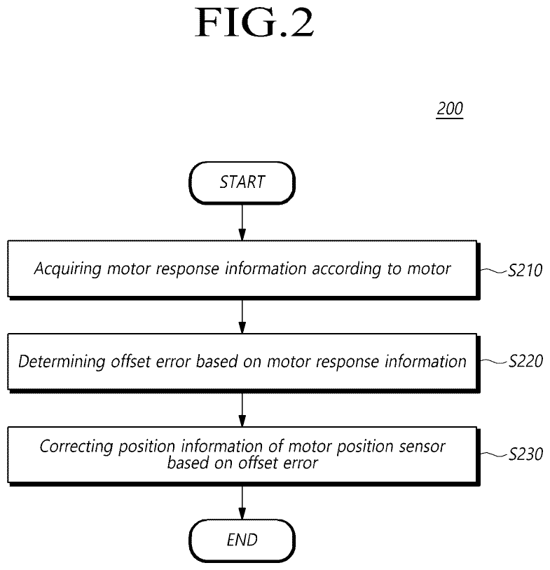

Hereinafter, with reference to FIGS. 2 to 8, it will be described a detailed description of specific operation procedures of an offset correction control process performed by a processor of the motor position sensor offset correction device according to the present disclosure.

FIG. 2 is an exemplary flowchart illustrating a motor position sensor offset correction process 200 according to an embodiment of the present disclosure.

According to an embodiment of the present disclosure, a processor may acquire motor response information corresponding to a motor (S210).

In an embodiment, the motor response information may be information related to a response occurring in response to a control input applied to the motor, and may include various data usable for motor control and status analysis. According to an embodiment, the motor response information may include a response value on a synchronous coordinate system. For example, the response value on the synchronous coordinate system may include a d-axis voltage component, a q-axis voltage component, a ratio between each voltage component, or a derivative value calculated from each voltage component. Additionally, the motor response information may further include, but is not limited to, state variables calculated or estimated by the processor, responses to high-frequency components or speed pulsations occurring during motor operation, or error components based on the difference between a control command and an actual response.

According to an embodiment, motor response information may be obtained in a driven state in which the motor is rotated by an external driving force, and in a zero-current control state.

Here, the “driven state” may refer to a state in which the motor is not operating independently but is rotated by an external force. For example, this may include a case in which the motor is manually rotated by the wheel rotation during vehicle traveling, or a case in which the motor is rotated by external test equipment. The zero-current control state may refer to a state in which the current applied to the motor is controlled to zero (0) to prevent the motor from generating own driving torque.

In the driven and zero-current control states, the stator voltage characteristics in the synchronous coordinate system may be derived as follows.

First, the d-q-axis voltage equation in the synchronous coordinate system may be as follows.

$${v}_{ds}^{e} = {R}_{s} {i}_{ds}^{e} + \frac{d}{dt} {ψ}_{d} - {ω}_{r} {ψ}_{d} ,$$

$${v}_{qs}^{e} = {R}_{s} {i}_{qs}^{e} + \frac{d}{dt} {ψ}_{q} - {ω}_{r} {ψ}_{d}$$

In a steady-state, since the time-varying component of the voltage disappears, so it can be expressed as follows.

$${v}_{ds}^{e} = {R}_{s} {i}_{ds}^{e} - {ω}_{r} {ψ}_{q} ,$$

$${v}_{qs}^{e} = {R}_{s} {i}_{qs}^{e} - {ω}_{r} {ψ}_{q}$$

Here, in the zero-current control state,

$${i}_{ds}^{e} and {i}_{qs}^{e}$$

are zero, so it may be summarized as follows.

$${v}_{ds}^{e} = - {ω}_{r} {ψ}_{f} ,$$

$${v}_{qs}^{e} = - {ω}_{r} {ψ}_{f}$$

That is, in the zero-current control state, the sinusoidal component of the stator voltage exists only in the q-axis, and all stator voltage is concentrated in the q-axis direction. In reality, the q-axis voltage in the coordinate system may be maintained as a voltage proportional to the stator flux and rotational speed.

That is, if the physical position of an actual rotor or the motor and the control coordinate system exactly match, the voltage component may exist only in the q-axis, and the d-axis component may become zero. In other words, in the absence of an offset, the following equation can be obtained.

$${v}_{ds}^{e} = 0 , {v}_{qs}^{e} = {ω}_{r} {ψ}_{f}$$

The present disclosure may utilize the characteristic that the stator voltage of the motor exists only in the q-axis direction under both the driven state and the zero-current control state. In this case, if a control coordinate system deviates from the actual rotor position by an offset error θ_{r,Offset,error}, a stator voltage vector may also have a voltage component in the d-axis direction due to the rotational error of the coordinate system. Therefore, the offset error may be estimated by utilizing the phenomenon of additional voltage components occurring in the d-axis direction when a coordinate system offset error exists.

If an offset error exists, the voltage components in the control coordinate system are expressed as follows.

$${v}_{ds}^{ctrl} = {ω}_{r} {ψ}_{f} \cdot sin ( {θ}_{r , Offset , error} ) , {v}_{qs}^{ctrl} = {ω}_{r} {ψ}_{f} \cdot cos ( {θ}_{r , Offset , error} )$$

That is, an additional d-axis voltage component may occur depending on the offset error, and the offset error may be determined by calculating a ratio of the d-axis and q-axis voltages.

In an embodiment, the processor may measure the d-axis voltage component and the q-axis voltage component of the motor stator voltage and generate motor response information based on the d-axis voltage component and the q-axis voltage component.

That is, in a driven state and a zero-current control state, the processor may decompose the motor stator voltage into d-axis and q-axis voltage components through coordinate system transformation. Furthermore, the processor may determine a coordinate system offset error by calculating the ratio between the voltage components, and the offset error may be utilized in the subsequent correction operation.

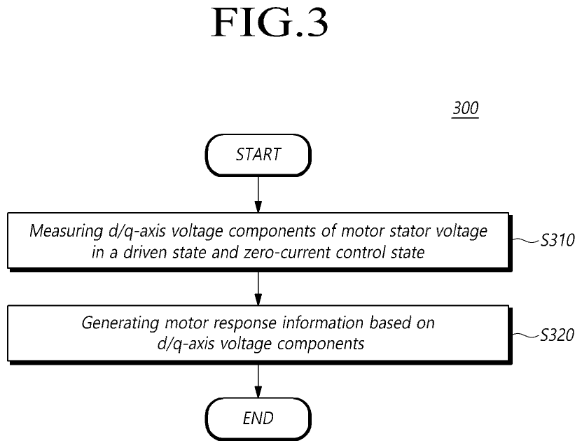

FIG. 3 is an exemplary flowchart illustrating a process 300 for obtaining motor response information according to an embodiment of the present disclosure.

More specifically, referring to FIG. 3, the processor may measure the d-axis and q-axis components of the motor stator voltage in a driven state and a zero-current control state (S310).

In an embodiment, the driven state may refer to a state in which the motor is passively rotated by an external driving source (e.g., vehicle inertia, external mechanical driving, or rotor inertia). In this case, the processor may establish a zero-current control state by setting a current control command applied to the motor to be zero (0) or discontinuing PWM operation. In this state, current flow into the motor may be blocked, so the voltage component applied to the motor stator may consist solely of the induced voltage due to the rotor motion. Therefore, this condition may provide a stable voltage response characteristic for evaluating offset errors.

In an embodiment, the processor may collect voltage signals applied to the stator windings of the motor using a sensor or voltage measurement circuit. The collected voltage signals may be converted into d-axis and q-axis voltage components by performing a coordinate system transformation (e.g., Park transformation or Clarke-Park transformation) based on rotor position information of the motor. That is, the processor may calculate the α-β axis coordinate components of the stator voltage, and transforms them into synchronous coordinate (i.e., d-q axis) components through coordinate system transformation to obtain the d-axis and q-axis voltage components. Through this, the d-axis and q-axis voltage components in the driven state and the zero-current control state may be computationally measured.

In addition, the processor may generate motor response information based on the d-axis voltage component and the q-axis voltage component (S320). The processor may derive the motor response information by calculating the ratio of the measured d-axis voltage component to the q-axis voltage component. The motor response information may be calculated by dividing the d-axis voltage component by the q-axis voltage component, and may be used as basic data for determining the coordinate system offset error.

The processor may generate the motor response information based on the following equation:

$$Motor response information = \frac{{v}_{ds}^{ctrl}}{{v}_{qs}^{ctrl}}$$

Here, the motor response information may be a value obtained by dividing the d-axis voltage component by the q-axis voltage component, representing the relative magnitude of the two voltage components. The calculated motor response information may be used to determine an offset error in a subsequent calculation process.

Referring again to FIG. 2, the processor may determine the offset error based on the motor response information (S220).

Specifically, the processor may determine the offset error by performing an inverse tangent operation (e.g., arc-tangent operation) based on the motor response information. This is because the motor response information is a value representing the rotational angle difference of the stator voltage vector. That is, since the direction of the stator voltage vector indicated by the d-axis and q-axis voltage components corresponds to the actual coordinate system offset error (θ_{r,Offset,error}) angle, so the processor may calculate the offset error (θ_{r,Offset,Cal}) using the following formula.

$${θ}_{r , Offset , Cal} = {tan}^{- 1} ( \frac{{v}_{ds}^{ctrl}}{{v}_{qs}^{ctrl}} ) = {tan}^{- 1} ( \frac{{ω}_{r} {ψ}_{f} \cdot sin ( {θ}_{r , Offset \_ error} )}{{ω}_{r} {ψ}_{f} \cdot cos ( {θ}_{r , Offset \_ error} )} )$$

That is, the motor response information precisely corresponds to the coordinate system offset error angle, and the processor may directly determine the offset error using only the inverse tangent operation.

Since the offset error determination method according to the present disclosure utilizes only the d-axis and q-axis voltage components of the stator voltage, i.e., the voltage information of the motor itself, the offset error determination method according to the present disclosure can be equally applied even if mechanical structures such as gears and reducers are assembled to the motor output shaft or housing.

Unlike methods utilizing forced alignment or high-precision encoders, which suffer from reduced identification accuracy due to clearance or friction in the mechanical components, the offset error determination method according to the present disclosure may have the advantage of directly calculating the offset error based on stator voltage information of the motor.

Therefore, the offset error determination method according to the present disclosure may enable accurate offset identification and correction in an assembled system without a separate mechanical disassembly process, thereby improving manufacturing process efficiency and maintenance convenience.

According to an embodiment of the present disclosure, the processor may correct the position information of a motor position sensor based on the offset error (S230).

In a specific embodiment, the processor may perform filter correction for the offset error using a state filter and correct the position information of the motor position sensor based on the filter-corrected offset error.

According to an embodiment, the state filter may receive the offset error calculated through an inverse tangent operation, extract a DC component of the offset error, and perform filtering to suppress the AC component. For example, the state filter may be implemented as an integral controller.

The integral controller has the characteristic of being able to effectively extract a DC component of an input value within a range where overshoot does not occur while naturally attenuating the high-frequency component.

The state filter based on the integral controller may have a structure in which the input and output signals contain identical components. Therefore, it is possible to acquire a highly reliable correction value by setting a gain of the DC component high and a gain of the high-frequency component relatively low.

The processor may utilize the state filter to extract the DC component of the offset error while effectively suppressing the effects of noise or speed fluctuations.

According to an embodiment of the present disclosure, the processor may determine a filter gain of the state filter based on a cutoff frequency of the state filter. More specifically, the processor may set the cutoff frequency (or bandwidth) of the state filter and calculate the filter gain of the state filter based on the set bandwidth value using the following equation:

K_{Offset}=2πf_{SF}

Here, K_{Offset} is the filter gain of the state filter (rad/s), and f_{SF} is the cutoff frequency (or state filter bandwidth) of the state filter (Hz). This configuration may ensure that the response characteristics of the state filter have a clear physical meaning by setting the filter gain of the state filter based on the electrical frequency characteristics, i.e., the filter bandwidth.

Specifically, the cutoff frequency of the state filter may serve as a factor determining the response speed when identifying offset errors and may contribute to ensuring consistent and stable identification response regardless of the size of an initial motor position sensor offset (MPS Offset).

The state filter of the present disclosure can operate to identify offset errors with the same response speed at all times, regardless of the initial MPS offset size, based on the set filter bandwidth. This configuration may prevent the problem of response speed or stability varying depending on the initial MPS offset size in typical integrator-based filters. Therefore, the state filter of the present disclosure may maintain consistent response regardless of the initial MPS offset size by setting the filter gain based on the filter bandwidth (e.g., cutoff frequency), while simultaneously improving noise suppression and identification stability.

According to a further embodiment, the processor may adjust the filter gain of the state filter based on at least one of the rotational speed, load, or temperature of the motor. The processor may initially set the filter gain of the state filter based on the cutoff frequency (or bandwidth) and then dynamically adjust the filter gain based on the driving state of the motor, thereby controlling the response speed when identifying offset errors.

In a specific embodiment, when the rotation speed of the motor is relatively low, the processor may set the filter gain of the state filter low, thereby slowing the response speed and suppressing the influence of rapid error changes or disturbances and ensuring identification stability.

Conversely, when the rotation speed of the motor is relatively high, the processor may set the filter gain of the state filter high, thereby quickly adjusting the response speed to enable rapid offset error identification. The configuration of adjusting the filter gain of the state filter based on the motor's driving state is intended to appropriately balance the identification response speed and stability depending on the driving state, thereby stably securing offset correction performance under various driving conditions.

According to an embodiment, the processor may generate corrected position information based on the corrected offset error and position information received from the motor position sensor.

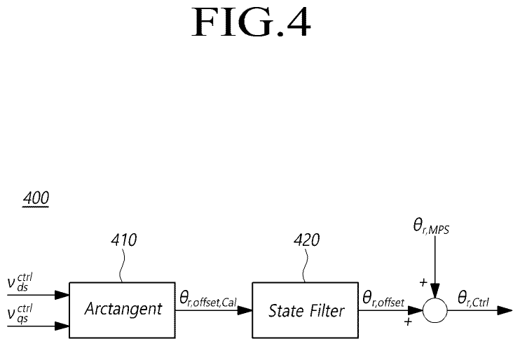

FIG. 4 is a block diagram schematically illustrating an offset correction flow of a motor position sensor according to an embodiment of the present disclosure.

Referring to FIG. 4, a motor position sensor offset correction device according to an embodiment of the present disclosure may generate a corrected offset error (θ_{r,Offset}) by applying a state filter 420 to an offset error (θ_{r,Offset,Cal}) calculated based on motor response information, and then apply the corrected offset error (θ_{r,Offset}) to position information (θ_{r,MPS}) received from the motor position sensor, thereby generating final corrected position information (θ_{r,ctrl}).

Specifically, the processor may first perform an inverse tangent operation or an arc-tangent operation 510 on motor response information based on the d-axis and q-axis voltage components

$$( {v}_{ds}^{ctrl} and {v}_{qs}^{ctrl} )$$

to calculate the offset error (θ_{r,Offset,Cal}) of the coordinate system.

The calculated offset error may be input to the state filter 420 and, after a filtering process, may be converted into a stable filter-corrected offset error (θ_{r,Offset}).

The processor may generate final position information, i.e., corrected position information (θ_{r,ctrl}), by adding the filter-corrected offset error (θ_{r,Offset}) output through the state filter 420 and the position information (θ_{r,MPS}) received from the motor position sensor.

The processor may generate final position information (i.e., corrected position information) by applying the offset correction and utilize the final position information for controlling a vehicle. In particular, the processor may provide stable and reliable corrected position information even if the mechanical structure related to the motor is assembled.

Additionally, according to an embodiment, the processor may perform an operation to store the corrected position information after generating the corrected position information. For example, the processor may store the corrected position information in non-volatile memory (e.g., EEPROM, flash memory) embedded in the electronic control unit (ECU) of the vehicle or in a separate correction-dedicated storage unit. The stored position information can be used as reference data in subsequent control cycles, thereby reducing the need for repetitive correction operations and improving the computational efficiency and control responsiveness of the overall system. In particular, the position accuracy of the motor position sensor can be stably maintained even under various environmental changes, such as temperature changes, vibration, and mechanical wear due to long-term use.

In various embodiments, the processor may accumulate and record a plurality of offset errors, calculate an offset error change rate based on the accumulated offset errors, and generate corrected position information if the offset error change rate exceeds a preset reference value.

More specifically, the processor may accumulate and store a plurality of offset errors calculated over a specific period of time and determine an offset error change rate based on the accumulated offset error data. For example, the processor may analyze the temporal change pattern of each offset error value to determine whether the offset error fluctuates rapidly over time.

If the calculated offset error change rate exceeds a preset reference value, the processor may determine that the offset error is outside a normal range and perform additional correction operation or update the stored offset error and generate corrected position information based on the updated offset error. The aforementioned configuration may be designed to continuously ensure the reliability of final position information by performing timely correction actions even if the offset error gradually accumulates or fluctuates due to long-term driving or changes in the external environment.

That is, the processor may actively detect trend changes in the offset error and automatically perform correction actions if necessary, thereby stably maintaining the position accuracy of the motor position sensor even during long-term operation.

In an embodiment, after generating corrected position information, the processor may generate a control signal for a motor based on the corrected position information to control an operation of the motor. In this case, the control signal generation and the motor control operation may be performed by the processor itself or may be performed by a vehicle control device that receives the corrected position information from the processor.

For example, the processor may perform a coordinate transformation, a commutation control, and/or a field oriented control (FOC) operation using the corrected position information, and may generate at least one of a voltage command, a current command, a torque command, a pulse-width modulation (PWM) command, or an inverter switching command as the control signal. Alternatively, the processor may transmit the corrected position information to the vehicle control device, and the vehicle control device may generate the control signal based on the received corrected position information.

In an embodiment, the processor may generate a d-axis current command and a q-axis current command based on a target torque and the corrected position information, and may generate the control signal such that an inverter applies phase voltages or phase currents corresponding to the d-axis current command and the q-axis current command to stator windings of the motor. In this case, the corrected position information may be used as feedback information for updating a synchronous coordinate system used for current regulation, thereby reducing a current control error and suppressing an unintended torque ripple caused by an offset of a motor position sensor.

In an embodiment, the processor may generate the control signal based on the corrected position information such that a steering assist torque, a reaction torque, or a driving torque is controlled according to a driving condition of a vehicle. For example, the processor may increase a q-axis current command to increase an assist torque when a steering input is large or when a vehicle speed is low, and may reduce the q-axis current command to improve stability when the vehicle speed is high. In this case, the processor may further adjust the control signal based on at least one of a motor speed, a motor temperature, a vehicle speed, or a battery state, while maintaining an accurate rotor angle for a control loop by using the corrected position information.

In a further embodiment, the processor may store the corrected position information and/or a corresponding offset correction value in a non-volatile memory and may reuse the stored information in a subsequent ignition cycle or a subsequent control cycle. For example, the processor may determine whether an update condition is satisfied based on at least one of an offset change rate, a temperature change, a vibration level, or an elapsed time, and may selectively update the stored corrected position information when the update condition is satisfied.

In a further embodiment, the processor may determine whether the corrected position information satisfies a validity condition and may perform a protective operation when the validity condition is not satisfied. For example, when a difference between position information received from the motor position sensor and the corrected position information exceeds a preset threshold, or when a fluctuation level of the corrected position information exceeds a preset range, the processor may determine that a correction reliability is degraded. In response thereto, the processor may generate the control signal to operate the motor in a degraded mode, limit a maximum torque, limit a rate of change of torque, and/or output a diagnostic notification.

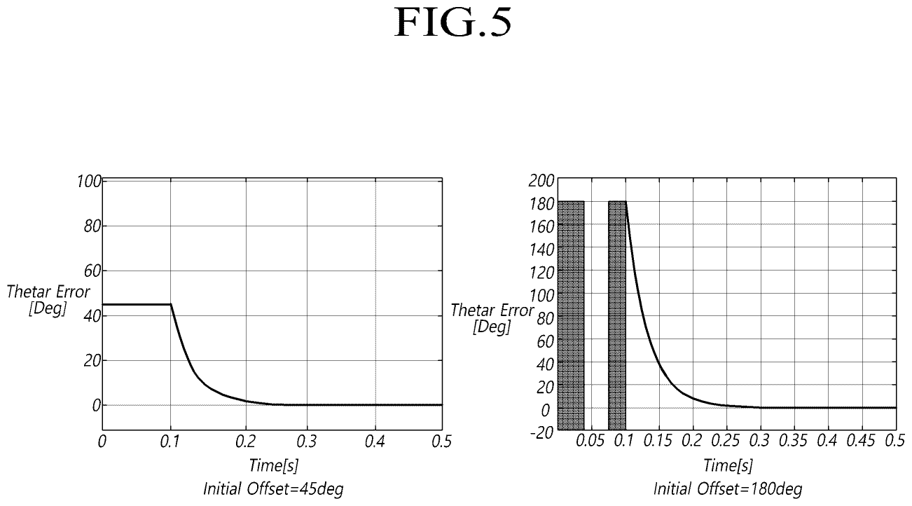

FIG. 5 illustrates experimental results demonstrating that stable offset correction is performed regardless of the initial offset value of MPS according to the motor position sensor offset correction method of the present disclosure.

In this embodiment, simulations were performed to verify whether consistent response characteristics are maintained even if the initial offset value changes. Specifically, the simulations were performed in an environment including speed pulsation conditions. The speed condition was set to 200+10 sin (wt) r/min, and the cutoff frequency of the state filter was set to 5 Hz. The identification start time was set to 0.1 s.

Under these conditions, the initial offset values of the motor position sensor were set to 45 degrees and 180 degrees, respectively, and the offset correction method according to the present disclosure has been applied to perform the correction operation.

Referring to FIG. 5, both graphs for the initial offset values of 45 degrees and 180 degrees represent that the offset error rapidly converges and reaches a steady state within approximately 73 ms (approximately 2.3τ).

In other words, it is confirmed that the offset error stabilizes within the same time constant regardless of the initial offset value. This demonstrates that the state filter proposed in the present disclosure may provide consistent correction response regardless of the initial offset value by setting the response speed to a constant value based on the cutoff frequency.

Furthermore, it is confirmed that the identification response characteristics may be consistently maintained according to the cutoff frequency, so that the offset correction method of the present disclosure can significantly reduce sensitivity to initial conditions. Therefore, the motor position sensor offset correction method according to the present disclosure may provide the rapid and stable offset compensation without relying on the level of the initial offset value.

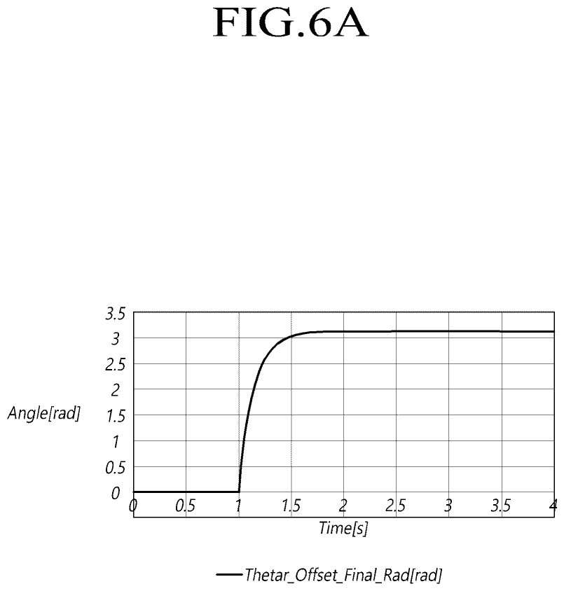

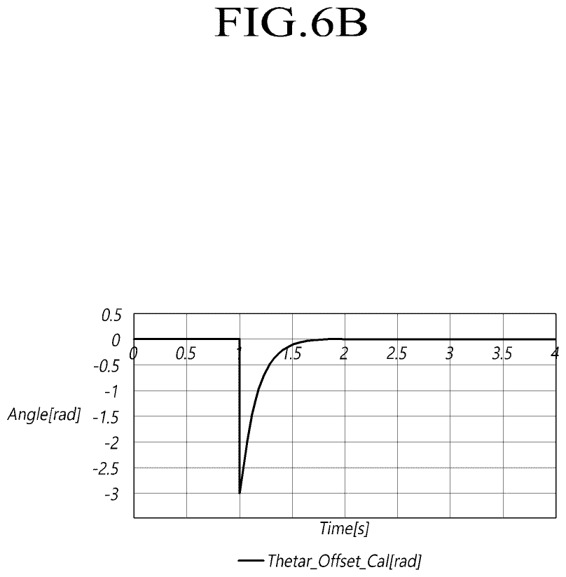

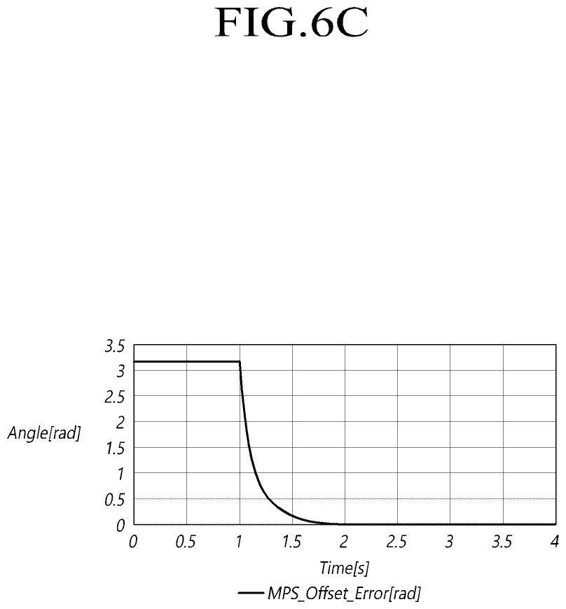

FIG. 6A to 6C illustrate experimental results confirming that, when the motor position sensor offset correction method according to the present disclosure is applied, the offset identification value stably converges within a certain period of time even if the initial offset value is large.

The experiments related to FIGS. 6A to 6C have been performed under conditions of an identification speed of 200 r/min, a state filter bandwidth of 1 Hz, and a current controller bandwidth of 700 Hz, and the identification start time is set to 1 second. The initial MPS offset value is set to 180 degrees.

Referring to FIG. 6A, the final identified offset value (θ_{r,Offset,final}) gradually increases over time and reaches a stable, steady-state value after a specific time point. Initially, the offset value increases slowly based on the calculation of motor response information and the response characteristics of the state filter. However, after a set time point, the offset value may change. This converge to a stable value without further demonstrates that the offset correction method according to the present disclosure may ultimately produce an accurate identification value even if the initial offset value is large (e.g., 180 degrees).

Referring to FIG. 6B, the instantaneous offset identification value (θ_{r,Offset,Cal}) calculated through the inverse tangent operation changes over time. Due to the nature of the inverse tangent operation, a very large, abrupt change in amplitude occurs immediately after the identification begins. This is due to noise in the input voltage signal and the initial offset value. However, as the signal passes through the state filter, high-frequency noise components are suppressed, leaving only the DC component, which gradually converges to a stable value. This means that the state filter of the present disclosure effectively performs noise removal and stabilization functions.

Referring to FIG. 6C, a graph represents the temporal change of the offset error (θ_{r,Offset,error}), which represents a phenomenon in which a large offset error initially exists, but rapidly decreases as the identification process progresses, ultimately converging to a stable value. This experimental result demonstrates that the motor position sensor offset correction method of the present disclosure enables rapid and accurate correction even with a large initial offset value, and can ensure the sufficient convergence speed and stability during the correction process.

The aforementioned experimental results demonstrate that the motor position sensor offset correction method according to the present disclosure can derive accurate offset correction values through a stable convergence process using the state filter, even with a very large initial offset value. In particular, the state filter effectively suppresses instantaneous noise and speed pulsation components generated during the inverse tangent operation, thereby enabling stable correction operation. Therefore, the motor position sensor offset correction method of the present disclosure may enable reliable offset correction even if the mechanical structure is assembled or the initial offset value is very large.

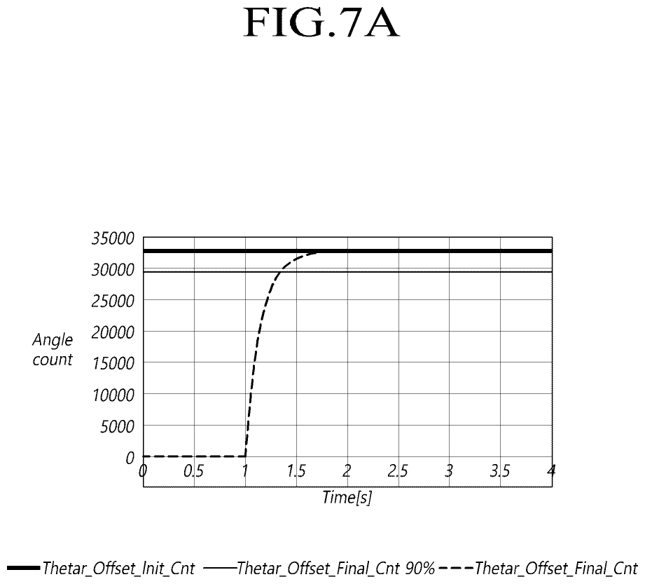

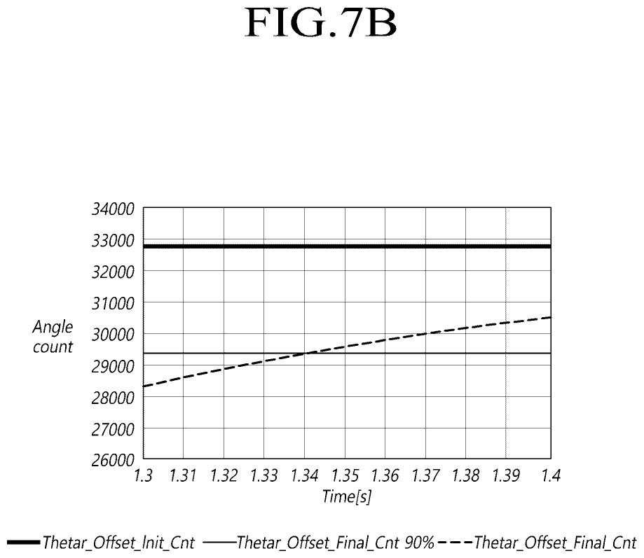

FIGS. 7A and 7B illustrate experimental results evaluating offset identification response characteristics and steady-state angle error using a motor position sensor offset correction method according to the present disclosure.

The experiments related to FIGS. 7A and 7B have been conducted under conditions of an identification speed of 200 r/min, a state filter bandwidth of 1 Hz, and a current controller bandwidth of 700 Hz, with the offset identification start time set to 1 second. In the experiment, rotor position data from the motor position sensor has been recorded in uint16 format (e.g., range 0 to 65535), and the offset identification has been performed with the initial MPS offset value set to 32768.

FIG. 7A illustrates a response characteristic in which the offset identification result θᵣ_Offset_Final_Cnt rapidly converges over time after the offset correction operation begins. The initial offset value has been set to 32768 (i.e., count unit, approximately 180 degrees), and it has been confirmed that the steady-state is reached approximately 1.5 seconds after the offset identification began. The line indicating the 90% level of the final convergence value (θr_Offset_Final_Cnt) is used as the baseline for determining the response speed based on the 90% level of the final convergence value, and the line corresponding to θᵣ_Offset_Init_Cnt represents the initial offset value at the start of the identification.

FIG. 7B is an enlarged view of the interval where the identification response converges in FIG. 7A, which represents a precision response characteristic between approximately 1.3 and 1.4 seconds. The line corresponding to θr_Offset_Final_Cnt continuously increases and passes the 90% baseline (i.e., θᵣ_Offset_Final_Cnt 90%), which is measured at approximately 1.34 seconds. This represents a 90% arrival time of approximately 339 ms, and indicates an error rate of approximately 7% compared to an arrival time of 366 ms based on the theoretical time constant. This result demonstrates a high degree of consistency between the measured data and the theoretical value, and demonstrates that the offset correction method of the present disclosure satisfies both real-time responsiveness and stability.

In addition, in this experiment, the rotor position data before offset correction has been expressed as a 16-bit integer (i.e., uint16, 0-65535), which may contain errors on the order of several μs due to slight voltage fluctuations resulting from voltage coordinate system and alignment state filter stabilization. However, the offset correction method of the present disclosure may provide stable position identification results despite these initial errors.

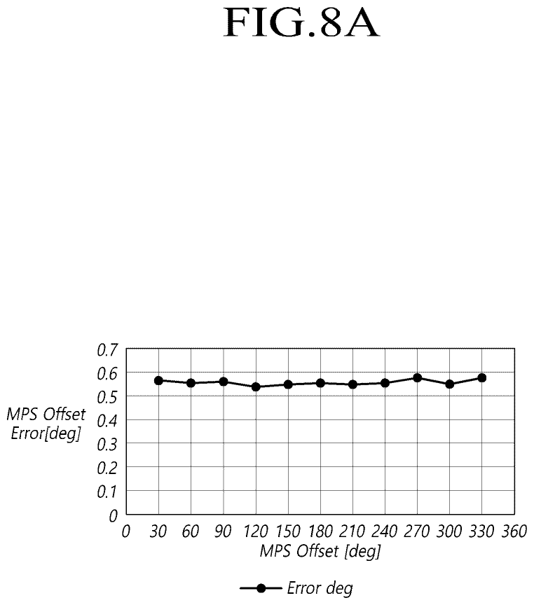

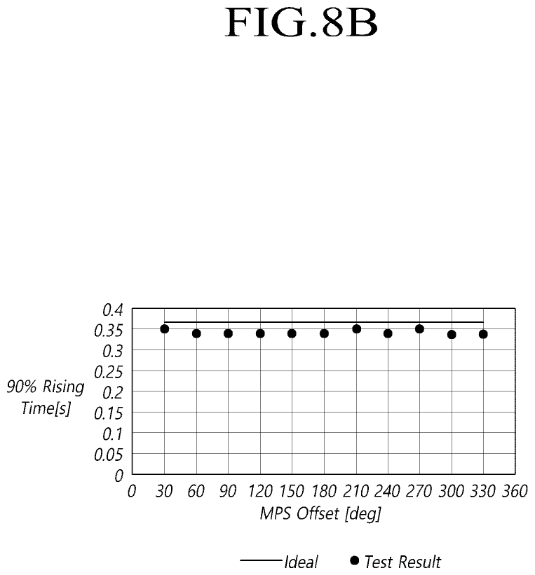

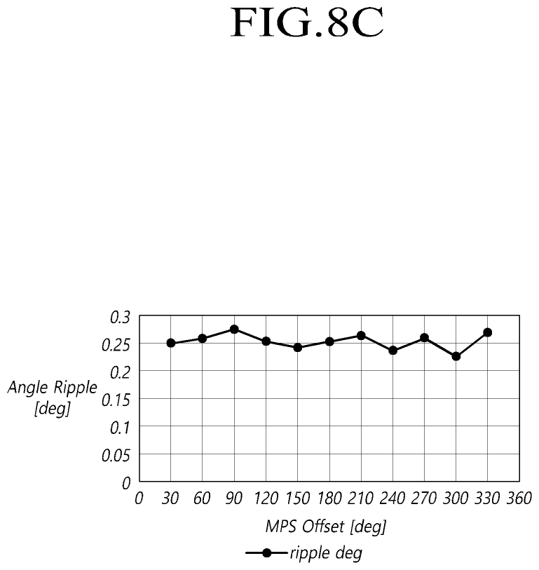

FIGS. 8A to 8C illustrate experimental results evaluating the identification accuracy, responsiveness, and steady-state pulsation characteristics according to changes in the initial offset value when applying the motor position sensor offset correction method of the present disclosure.

The experiments related to FIGS. 8A to 8C have been performed under conditions of an identification speed of 200 r/min, with a state filter bandwidth of 1 Hz and a current controller bandwidth of 700 Hz. Each experiment has been conducted by applying different initial MPS offset values to examine changes in identification accuracy and responsiveness.

FIG. 8A is a graph showing the identification accuracy (e.g., angular error) according to the initial MPS offset value, and demonstrating that identification accuracy is hardly affected even when the initial offset value varies from 0 to 360 degrees. The angular error remains within the range of approximately 0.53 to 0.58 degrees throughout the entire range, with an average value of approximately 0.56 degrees. This indicates that the offset correction method of the present disclosure can provide excellent identification accuracy regardless of the initial offset value of MPS.

FIG. 8B illustrates the results of evaluating the response characteristics (e.g., 90% arrival time) according to the initial MPS offset value. Under all experimental conditions, the response time is within a range from approximately 337 ms to 349 ms, which demonstrates a stable response speed remarkably close to the theoretical value of 366 ms. Furthermore, it can be confirmed that there is little difference in response time depending on the initial offset value.

FIG. 8C illustrates the results of evaluating steady-state pulsation (e.g., angular pulsation range) according to the initial MPS offset value. The angular pulsation remains very stable within approximately 0.3 degrees across the entire range, which suggests the potential for further improvement through identification speed or additional configuration changes.

These experimental results clearly demonstrate that the offset correction method of the present disclosure is not significantly affected by changes in the initial MPS offset value and provides excellent performance in terms of identification accuracy, responsiveness, and steady-state stability.

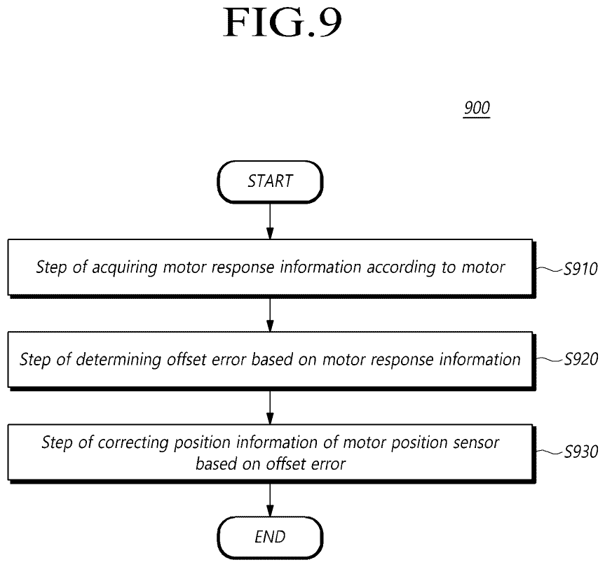

FIG. 9 is an exemplary flowchart illustrating an offset correction method of a motor position sensor according to an embodiment of the present disclosure. The steps illustrated in FIG. 9 may be reordered as needed, and at least one step may be omitted or added. The steps illustrated in FIG. 9 are merely an embodiment of the present disclosure, and the scope of the present disclosure is not limited thereto. For features of the content illustrated in FIG. 9 that overlap with those previously described with respect to FIGS. 1 to 8, reference will be made to the contents of FIGS. 1 to 8, and their description will be omitted herein.

According to an embodiment of present disclosure, the offset correction method of the motor position sensor may include a step (S910) of acquiring motor response information corresponding to the motor.

The motor response information may be acquired in a driven state in which the motor is rotated by an external driving force and in a zero-current control state.

The step of acquiring the motor response information may include a step of measuring the d-axis voltage component and the q-axis voltage component of the motor stator voltage, and a step of generating motor response information based on the d-axis voltage component and the q-axis voltage component.

According to an embodiment of the present disclosure, the offset correction method of the motor position sensor may include a step (S920) of determining an offset error based on the motor response information.

According to an embodiment, the offset error may be calculated without the influence of clearance or friction of the mechanical structure in a state in which the mechanical structure is assembled to an output shaft or a housing of the motor.

Furthermore, in an embodiment, the step of determining the offset error may include determining the offset error by performing an inverse (or arc) tangent operation based on the motor response information.

According to an embodiment of the present disclosure, the offset correction method of the motor position sensor may include a step (S930) of correcting position information of the motor position sensor based on the offset error.

In an embodiment, the step of correcting the position information of the motor position sensor may include a step of performing filter correction for the offset error using a state filter and a step of correcting the position information of the motor position sensor based on the filter-corrected offset error.

In addition, in an embodiment, the step of correcting the position information of the motor position sensor may include the step of generating corrected position information based on the filter-corrected offset error and the position information received from the motor position sensor, and the step of storing the corrected position information.

In addition, in an embodiment, the step of correcting the position information of the motor position sensor may include the step of accumulating and recording a plurality of offset errors, calculating an offset error change rate based on the accumulated plurality of offset errors, and performing position correction by generating corrected position information when the offset error change rate exceeds a preset reference value.

In addition, in an embodiment, the step of correcting the position information of the motor position sensor may include determining a filter gain of a state filter based on a cutoff frequency of the state filter.

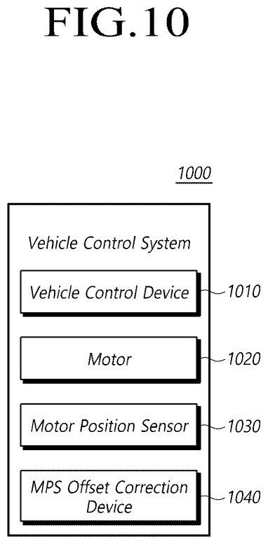

FIG. 10 is a block diagram illustrating a configuration of a vehicle control system according to another embodiment of the present disclosure.

Referring to FIG. 10, the vehicle control system 1000 of the present disclosure may include a vehicle control device 1010, a motor 1020, a motor position sensor 1030, and an offset correction device 1040 of a motor position sensor.

The components of the vehicle control system 1000 described above are merely exemplary, and additional components may be included depending on the design purpose or driving environment of the system. For example, the vehicle control system 1000 may additionally include a battery management system (BMS), a communication module (e.g., CAN, Ethernet communication device), a temperature sensor, a rotational speed sensor, etc. These components may monitor the thermal state, rotational speed, or external communication of the motor, or transmit control signals. In addition, additional components such as an energy recovery system, a power distribution device, or a driving mode switching device may be included depending on the type of vehicle (e.g., electric vehicle, hybrid vehicle, internal combustion engine vehicle). These additional components may be selectively included or omitted depending on the design purpose, vehicle type, or driving environment of the vehicle control system, and may expand the functional scope and application fields of the vehicle control system. Some components may be omitted or replaced with devices performing other functions.

According to an embodiment, a vehicle control system 1000 may include a vehicle control device 1010 that controls the driving of a vehicle. The vehicle control device 1010 may be an electronic control unit (ECU) or a corresponding control device that controls various electronic systems within the vehicle, and may perform various control functions, including driving, steering, braking, and energy management of the vehicle.

More specifically, the vehicle control device 1010 may receive driver input signals (e.g., accelerator pedal, brake pedal, steering device, etc.) and vehicle status signals (e.g., speed, rotational speed, motor temperature, remaining battery capacity, etc.) and generate a control command for the motor 1020 based on the received signals. In addition, the vehicle control device 1010 may utilize position information received from a motor position sensor 1030 and corrected position information provided from the offset correction device 1040 to perform precise motor driving control.

The vehicle control device 1010 may exchange data with multiple electronic devices via an in-vehicle communication network (e.g., CAN, LIN, FlexRay, Ethernet, etc.), and may also perform linkage e with external diagnostic equipment or remote control functions.

In addition, the vehicle control system 1000 may include the motor 1020 for controlling the steering of the vehicle. The motor 1020 or the electric motor may be a device that assists a steering force of a steering wheel in response to a driver's steering input or independently generates steering force as needed, and may be a major component for controlling the steering performance and steering feeling of the vehicle.

The motor 1020 may convert electrical energy into mechanical energy and transmit the mechanical energy to a steering mechanism, thereby controlling the steering angle and reaction force characteristics of the vehicle. In addition, the rotation speed and output torque may be adjusted in real time according to the vehicle's driving speed, road surface conditions, or control mode, and the motor may operate in conjunction with the vehicle control device 1010 for stable steering control.

In addition, the vehicle control system 1000 may include a motor position sensor 1030 that detects the rotational position of the motor 1020.

The motor position sensor 1030 may be a sensor device that detects the physical position of a rotor of the motor and provides position information for controlling the motor 1020. Specifically, the motor position sensor 1030 may detect the absolute or relative position of the rotor of the motor, and for this purpose, various sensing methods such as a Hall sensor, a resolver, and an encoder may be applied. Generally, the motor position sensor may be coupled to an output shaft of the motor to measure information such as the rotation angle, speed, and direction, and may output the information in the form of a digital or analog signal.

In an embodiment, the motor position sensor 1030 may operate in conjunction with the vehicle control device 1010 and the offset correction device 1040. The motor position sensor 1030 may provide position information containing an offset error due to mechanical clearance, friction, or assembly deviation that may occur during the driving environment or the mechanism assembly process, and such an error may be precisely corrected through the offset correction device 1040.

In addition, the vehicle control system 1000 may include the offset correction device 1040 of the motor position sensor 1030 that corrects the position information of the motor position sensor 1030.

The offset correction device 1040 may generate motor response information based on the stator voltage of the motor 1020, calculate an offset error based on the motor response information, and correct the position information of the motor position sensor based on the offset error.

Specifically, the offset correction device 1040 may measure the stator voltage of the motor while the motor is in a driven state and a zero-current control state, decompose the stator voltage into d-axis and q-axis voltage components through coordinate system transformation, and then calculate a ratio of the voltage components to generate motor response information.

Thereafter, the generated motor response information may be converted into a coordinate system offset error through an inverse (or arc) tangent operation, and the calculated offset error may be filtered through a state filter to be utilized as a stable correction value. The correction value may be applied to the position information received from the motor position sensor 1030 to generate final corrected position information. Furthermore, the device has the advantage of enabling precise offset correction without separate disassembly even when the mechanical structure is assembled.

Therefore, the offset correction device 1040 of the present disclosure may provide stable position information even in the mechanical assembly state or under changes in driving environment, thereby improving vehicle control performance and driving stability.

The processes, systems, and methods described herein may be implemented by a computing system in response to a processor executing an array of instructions contained in main memory. These instructions may be read into main memory from another computer-readable medium, such as a storage device. Execution of the array of instructions contained in main memory causes the computing system to perform the exemplary processes described herein. In a multiprocessing arrangement, one or more processors may also be used to execute the instructions contained in main memory. Hardwired circuitry may be used in place of or in conjunction with software instructions in conjunction with the systems and methods described herein. The systems and methods described herein are not limited to any specific combination of hardware circuitry and software.

Although an example computing system has been described, the subject matter including the operations described in this specification can be implemented in other types of digital electronic circuitry, or in computer software, firmware, or hardware, including the structures disclosed in this specification and their structural equivalents, or in combinations of one or more of them.

The terms “data processing system,” “computing device,” “component,” or “data processing apparatus” encompass various apparatuses, devices, and machines for processing data, including by way of example a programmable processor, a computer, a system on a chip, or multiple ones, or combinations of the foregoing. The apparatus can include special-purpose logic circuitry, e.g., an FPGA (field-programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. The components of system can include or share one or more data processing apparatuses, systems, computing devices, or processors.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing or more computer programs (e.g., components of the data processing system) to perform actions by operating on input data and generating output. The processes and logic flows can also be performed by, and apparatuses can also be implemented as, special purpose logic circuitry, e.g., an FPGA (field-programmable gate array) or an ASIC (application-specific integrated circuit). Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter and the operations described in this specification can be implemented in digital electronic circuitry or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial-access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices). The operations described in this specification can be implemented as operations performed by a data processing apparatus on data stored on one or more computer-readable storage devices or received from other sources.

The above description has been presented to enable any person skilled in the art to make and use the technical idea of the present disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the present disclosure. The above description and the accompanying drawings provide an example of the technical idea of the present disclosure for illustrative purposes only. That is, the disclosed embodiments are intended to illustrate the scope of the technical idea of the present disclosure. Thus, the scope of the present disclosure is not limited to the embodiments shown, but is to be accorded the widest scope consistent with the claims.

What is claimed is:

1. An offset correction device of a motor position sensor (MPS), comprising:
a memory storing at least one instruction; and
at least one processor executing the at least one instruction,
wherein the at least one processor is configured to, by executing the at least one instruction:
acquire motor response information corresponding to a motor;
determine an offset error based on the motor response information;
correct position information of the MPS based on the offset error; and
generate a control signal for the motor based on the corrected position information to control an operation of the motor.

2. The offset correction device of claim 1, wherein the at least one processor is further configured to acquire the motor response information in a driven state in which the motor is rotated by an external driving force and in a zero-current control state.

3. The offset correction device of claim 2, wherein the at least one processor is further configured to:
measure a d-axis voltage component and a q-axis voltage component of a motor stator voltage; and
generate the motor response information based on the d-axis voltage component and the q-axis voltage component.

4. The offset correction device of claim 1, wherein the at least one processor is further configured to determine the offset error by performing an inverse tangent operation based on the motor response information.

5. The offset correction device of claim 4, wherein the at least one processor is further configured to:
perform a filter correction to extract a direct current (DC) component from the offset error using a state filter; and
correct the position information of the MPS based on a filter-corrected offset error.

6. The offset correction device of claim 5, wherein the at least one processor is further configured to determine a filter gain of the state filter based on a cutoff frequency of the state filter.

7. The offset correction device of claim 5, wherein the at least one processor is further configured to generate corrected position information based on the filter-corrected offset error and the position information received from the MPS.

8. The offset correction device of claim 7, wherein the at least one processor is further configured to, when the corrected position information is generated, store the corrected position information.

9. The offset correction device of claim 7, wherein the at least one processor is further configured to:
accumulate and record a plurality of offset errors;
determine an offset error change rate based on the accumulated plurality of offset errors; and
generate the corrected position information when the offset error change rate exceeds a preset reference value.

10. An offset correction method of a motor position sensor (MPS), comprising:
acquiring motor response information corresponding to a motor;
determining an offset error based on the motor response information;
correcting position information of the MPS based on the offset error; and
generating a control signal for the motor based on the corrected position information to control an operation of the motor.

11. The offset correction method of claim 10, wherein the acquiring includes acquiring the motor response information in a driven state in which the motor is rotated by an external driving force and in a zero-current control state.

12. The offset correction method of claim 11, wherein the acquiring further includes:
measuring a d-axis voltage component and a q-axis voltage component of a motor stator voltage; and
generating the motor response information based on the d-axis voltage component and the q-axis voltage component.

13. The offset correction method of claim 12, wherein the determining includes determining the offset error by performing an inverse tangent operation based on the motor response information.

14. The offset correction method of claim 13, wherein the correcting includes:
performing a filter correction to extract a direct current (DC) component from the offset error using a state filter; and
correcting the position information of the MPS based on a filter-corrected offset error.

15. The offset correction method of claim 14, wherein the correcting includes determining a filter gain of the state filter based on a cutoff frequency of the state filter.

16. The offset correction method of claim 14, wherein the correcting includes generating corrected position information based on the filter-corrected offset error and the position information received from the MPS.

17. The offset correction method of claim 16, wherein the correcting includes, when the corrected position information is generated, storing the corrected position information.

18. The offset correction method of claim 16, wherein the correcting includes:
accumulating and recording a plurality of offset errors;
determining an offset error change rate based on the accumulated plurality of offset errors; and
generating the corrected position information if the offset error change rate exceeds a preset reference value.

19. A vehicle control system comprising:
a vehicle control device for controlling a driving of a vehicle;
a motor for driving the vehicle;
a motor position sensor (MPS) for detecting a rotational position of the motor; and
an offset correction device configured to generate motor response information based on a stator voltage of the motor, determine an offset error based on the motor response information, and correct position information of the MPS based on the offset error, wherein the vehicle control device is configured to generate a control signal for the motor based on the corrected position information to control an operation of the motor.

20. The vehicle control system of claim 19, wherein the offset correction device is further configured to generate the motor response information based on a d-axis voltage component and a q-axis voltage component of the stator voltage obtained in a driven state in which the motor is rotated by an external driving force and in a zero-current control state.
